(19) United States
(12) Patent Application Publication
(10) Pub. No.: US 2001/0016068 A1
(43) Pub. Date: Aug. 23, 2001

(54) ELECTRONIC DOCUMENT GENERATING APPARATUS, ELECTRONIC DOCUMENT GENERATING METHOD, AND PROGRAM THEREOF

(76) Inventor: KAZUKI SHIBATA, TOKYO (JP)

Correspondence Address: FOLEY & LARDNER, WASHINGTON HARBOUR, 3000 K STREET NW SUITE 500, P O BOX 25696, WASHINGTON, DC, 200078696

(21) Appl. No.: 08/976,495

(22) Filed: Nov. 24, 1997

(30) Foreign Application Priority Data
Dec. 2, 1996 (JP) 08-321471

(51) Int. Cl. G06K 9/46; G06K 9/66; G06K 9/72

(52) U.S. Cl. 382/195

(57) ABSTRACT

A document image that is captured from image inputting unit and stored in image storing portion is displayed on displaying unit. Regions of the document displayed on displaying unit are designated using position inputting unit. Thereafter, attributive information is designated to the individual regions using character inputting unit.

Character recognizing portion recognizes characters for the individual regions with a dictionary corresponding to the attributive information. The resultant data is stored in text storing portion. Image extracting portion extracts image data corresponding to the attributive information and stores the extracted image data to image data storing portion. Markup portion performs a markup process for character regions and image regions corresponding to the attributive information. The resultant data is stored to text storing portion. Outputting portion outputs data stored in text storing portion and data stored in image data storing portion as an SGML file and an image data file, respectively.

### BACKGROUND OF THE INVENTION

1. Field of the Invention

The present invention relates to an electronic document generating apparatus, an electronic document generating method, and a program thereof, and in particular to an electronic document generating apparatus for automatically recognizing characters, an electronic document generating method thereof, and a program thereof.

2. Description of the Related Art

Methods for generating electronic documents are mainly categorized in two types. In the first type, a document is electrically converted into image (picture) information. In the second method, characters are recognized as code. In the first method, even if an original document contains drawings/graphs, the document can be converted into image information without need to distinguish character strings from drawings/graphs. Thus, the process can be easily performed. However, from the viewpoints of the data amount of the electronic document and later applications thereof, it is preferable to convert character strings into codes. Therefore, an electronic document generating apparatus for distinguishing character strings from drawings/graphs and converting the character strings and the drawings/graphs into code information and image information, respectively has been proposed and practically used.

In such an electronic document generating apparatus, an original document is read by a scanner or the like. The operator designates a predetermined document format so as to distinguish character string regions from drawing/chart regions. Alternatively, the operator designates character string regions and drawing/chart regions so as to cause the apparatus to distinguish these regions each other. Moreover, in Japanese Patent Laid-Open Publication No. 2-59979, an electronic document generating apparatus that automatically distinguishes character string regions from drawing/chart regions is disclosed.

According to such related art references, character strings in character strings regions that have been designated or determined are automatically recognized and converted into codes. The coded character information and drawing/chart image information are separately stored.

The character information that has been electrically converted normally does not have the format of the original document. Thus, the character information is sometimes marked up in a markup language such as SGML (Standard Generalized Markup Language).

The conventional markup process is performed after a sequence of an electronic document generating process has been completed.

In the related art references, there are the following disadvantages.

As a first disadvantage, in the conventional electronic document generating apparatus, unless the font type and font size of characters are the same, the character recognition ratio deteriorates.

This is because the dictionary of the conventional electronic document generating apparatus that is optimized for only predetermined font size and font type is applied to characters of different font size or of different font type.

As a second disadvantage, in an automatic character recognizing process of the conventional electronic document generating apparatus, it is difficult to structure a document in a markup language such as SGML or to apply an automatic markup system.

This is because an automatic character recognizing process causes a document structure which consist of titles, chapters, paragraphs, and so forth and information such as font sizes, font types, and so forth to be lost.

As a third disadvantage, when an automatic character recognizing process and a markup process are performed for a document containing drawings/charts, an editing process is required.

This is because the automatic character recognizing process causes information other than character codes in character string regions to be lost and the positions of the drawings/charts to become indefinite.

### SUMMARY OF THE INVENTION

An object of the present invention is to provide an electronic document generating apparatus with a high character recognition ratio, an electronic document generating method thereof, and a program thereof.

Another object of the present invention is to provide an electronic document generating apparatus that allows electronic data to be generated with a captured document image in a markup language and a markup process to be easily performed for a document containing drawings/charts, an electronic document generating method thereof, and a program thereof.

According to the present invention, there is provided an electronic document generating apparatus for reading a document and recognizing characters from the document, comprising a region designating means for designating regions of the document, an inputting means for inputting attributive information for the regions, an attribute storing means for storing the regions and the attributive information in such a manner that the regions and the attributive information correlate, a dictionary group having dictionaries corresponding to a plurality of font types, and a character recognizing means for selecting proper dictionaries from the dictionary group with reference to the attributive information and recognizing characters for the regions.

According to the present invention, the electronic document generating apparatus further comprises an image extracting means for extracting image data from the region that has been designated as a drawing/chart by the attributive information in case that the document contains the drawing/chart.

According to the present invention, the electronic document generating apparatus further comprises a markup processing means for executing a markup process for the result of the character recognition and the image extraction for each of the regions.

When regions are assigned for a document captured in the apparatus and attributes are designated to the individual regions, characters for the individual regions are recognized corresponding to the designated attributes. In addition, the markup process is performed corresponding to the attributes designated to the individual regions.

These and other objects, features and advantages of the present invention will become more apparent in light of the following detailed description of a best mode embodiment thereof, as illustrated in the accompanying drawings.

### BRIEF DESCRIPTION OF DRAWINGS

FIG. 1 is a block diagram showing the structure of an electronic document generating apparatus according to an embodiment of the present invention;

FIG. 2 is a flow chart for explaining a process of the electronic document generating apparatus according to the embodiment of the present invention;

FIG. 3 is a schematic diagram showing an example of a document that is read by the electronic document generating apparatus according to the embodiment of the present invention;

FIG. 4 is a schematic diagram for explaining a region designating process for the example of the document shown in FIG. 3, the region designating process being performed by the electronic document generating apparatus according to the embodiment of the present invention;

FIG. 5 is a schematic diagram for explaining attributive information for the example of the document shown in FIG. 3, the attributive information being input and used by the electronic document generating apparatus according to the embodiment of the present invention;

FIG. 6 is a schematic diagram showing the result of an automatic character recognizing process for the example of the document shown in FIG. 3, the automatic character recognizing process being performed by the electronic document generating apparatus according to the embodiment of the present invention; and

FIG. 7 is a schematic diagram showing SGML for the example of the document shown in FIG. 3, the SGML being output by the electronic document generating apparatus according to the embodiment of the present invention.

### DESCRIPTION OF PREFERRED EMBODIMENT

Next, with reference to the accompanying drawings, an embodiment of the present invention will be described.

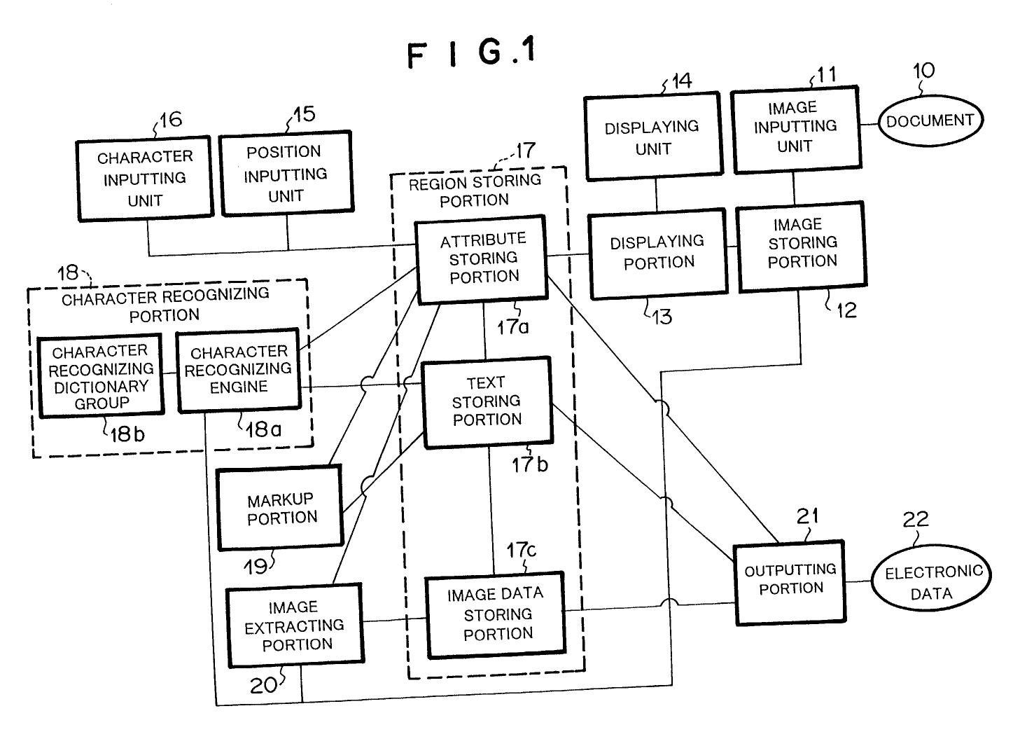

FIG. 1 shows an electronic document generating apparatus according to an embodiment of the present invention. The electronic document generating apparatus shown in FIG. 1 comprises image inputting unit 11, image storing portion 12, displaying portion 13, displaying unit 14, position inputting unit 15, character inputting unit 16, region storing portion 17, character recognizing portion 18, markup portion 19, image extracting portion 20, and outputting portion 21. Scanner captures a document 10 as an image. Image inputting unit 11 is a scanner for example. Image storing portion 12 stores image data captured by image inputting unit 11. Displaying portion 13 generates a signal for displaying unit 14. Displaying unit 14 is a CRT (Cathode Ray Tube) for example. Position inputting unit 15 designates at least one region for the image displayed on displaying unit 14. Position inputting unit 15 is a mouse for example. Character inputting unit 16 inputs attributive information of individual regions that have been designated. Character inputting unit 16 is a keyboard for example. Region storing portion 17 stores information of the individual regions. Character recognizing portion 18 recognizes characters for the individual regions. Markup portion 19 performs a markup process for the individual regions. Image extracting portion 20 extracts data of a drawing region (also referred to as image region) from image data stored in the image storing portion 12. The outputting portion 21 outputs electronic data.

Region storing portion 17 comprises attribute storing portion 17a, text storing portion 17b, and image data storing portion 17c. Attribute storing portion 17a stores position information and attributive information received from position inputting unit 15 and character inputting unit 16, respectively. Text storing portion 17b stores text data, which is the recognized result of character recognizing portion 18. Image data storing portion 17c stores the extracted result of image extracting portion 20.

Character recognizing portion 18 comprises character recognizing engine 18a and character recognizing dictionary group 18b. Character recognizing engine 18a recognizes characters. Character recognizing dictionary group 18b has a plurality of types of character recognizing dictionaries that character recognizing engine 18a uses.

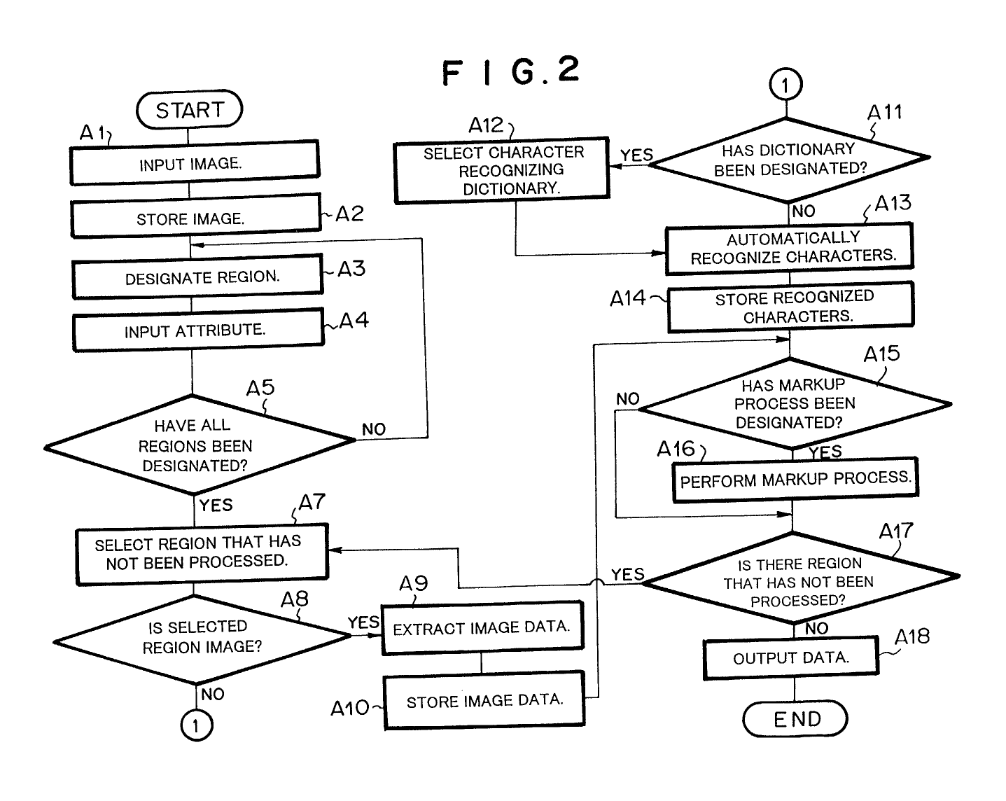

Next, with reference to FIG. 2, the process of the electronic document generating apparatus shown in FIG. 1 will be described.

First of all, image inputting unit 11 reads a document to be electrically converted and outputs image data at step A1. The image data that is output from image inputting unit 11 is supplied to image storing portion 12 and stored therein at step A2. Displaying portion 13 reads image data stored in image storing portion 12 and displays a document image on the screen of displaying unit 14.

Thereafter, the operator of the apparatus designates regions on the document image displayed on displaying unit 14 with position inputting unit 15 at step A3. In this example, the operator designates detailed regions such as titles, items, or paragraphs rather than simple regions such as character string regions or drawing/chart regions. In this manner, a font size, a font type, and so forth are unified in one region. Next, the operator inputs attributes used for an automatic character recognizing process, a markup process, an automatic image data extracting process, and so forth with character inputting unit 16 at step A4. Thus, position information that represents the range and the position of the designated region and attributive information that has been input are stored in attribute storing portion 17a at step A4.

The operator continuously designates regions and inputs attributes until all the regions for the automatic character recognizing process, the markup process, and the automatic image data extracting process have been treated (at step A5). Alternatively, it is possible that after designating all the regions rather than designating one region, the operator input attributes for the regions. In this case, so as to associate regions with attributes, the operator uses inputting unit 15 as well as position inputting unit 15.

After the operator has designated all regions and input attributes thereof, he or she inputs a data input end command with the use of position inputting unit 15 or character inputting unit 16 at step A5. Thereafter, the operator selects a region for the automatic character recognizing process, the markup process, or the automatic image data extracting process from regions which has not been processed with the use of position inputting unit 15 at step A7.

When the operator has selected the region to be processed, the attributive information thereof is acknowledged by a controlling unit which is not shown. If the selected region is judged to be image at step A8, image extracting portion 20 is started up. Image extracting portion 20 extracts data of the region from the image data stored in image storing portion 12 at step A9. Image extracting portion 20 stores the extracted data in image data storing portion 17c at step A10.

If the selected region is judged to be a character region at step A8, character recognizing engine 18a is started up. Character recognizing engine 18a determines whether or not the attributive information of the region contains information that designates a dictionary type at step A11. When a dictionary has been designated, the dictionary is selected from the character recognizing dictionary group 18b at step A12. When a dictionary has not been designated, a predetermined dictionary is selected. Then character recognizing engine 18a executes the automatic character recognizing process at step A13. Data of the selected region is extracted from the image storing portion 12 in this case as well as in the case that the selected region is image. In addition, the character recognizing process is performed corresponding to information of character writing direction, which indicates character string is written in horizontal or vertical, contained in the attributive information. The result of the character recognizing process is stored in text storing portion 17b at step A14.

After image data has been extracted or the automatic character recognizing process has been completed, with reference to the attributive information of the region, it is determined at step A15 whether or not to the markup process should be performed. If the markup process should be performed, the markup portion 19 is started up. In the case that the attribute of the region is character string, he markup portion 19 temporarily retrieves data stored in text storing portion 17b, performs the markup process for the retrieved data corresponding to the attributive information, and stores the resultant data to text storing portion 17b at step A16. In the case that the attribute of the region is image, the markup process is performed for the image region in such a manner that the relationship between the image region and the image data is represented. The resultant data is stored in the text storing portion 17b in this case as well as in the case that the attribute of the region is character string.

When there is a region that has not been processed as the determined result at step A17, the flow returns to step A7. At step A7, a region that has not been processed is selected. Thereafter, steps A8 to A16 are repeated.

When steps A8 to step A16 have been performed for all the regions as the determined result at step A17, the flow advances to step A18. At step A18, the outputting portion 21 is started up. The outputting portion 21 determines output sequence of the mixture of text data and image data of each region based on the attributive information and position information of each region stored in attribute storing portion 17a and output data according to the determined output sequence to form electronic data 22.

As described above, according to the embodiment of the present invention, dictionaries corresponding to a plurality of font types (and/or font sizes) are provided in the character recognizing dictionary group 18b. A dictionary is designated corresponding to the attributive information. Thus, in the automatic character recognizing process, high character recognition accuracy is obtained.

Since each region is marked up, the automatic markup process can be performed.

In addition, since the markup process can be performed regardless of whether each region is a character region or a drawing/chart region, no editing process is required.

In the above-described embodiment, when characters are recognized, data of a selected region is extracted from image storing portion 12. Alternatively, data stored in image storing portion 12 may be stored in attribute storing portion 17a along with attributive information.

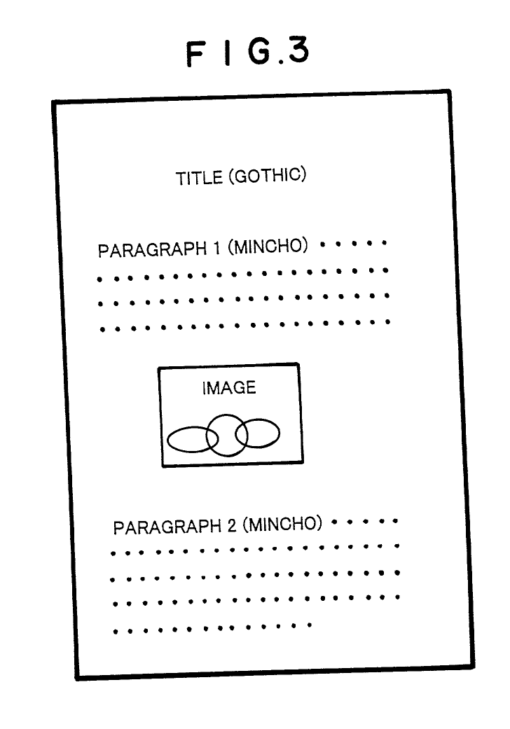

Next, with reference to FIGS. 3 to 7, the embodiment of the present invention will be described. In this example, a document shown in FIG. 3 is converted into electronic information.

The document shown in FIG. 3 is composed of a first text (paragraph 1), an image, and a second text (paragraph 2). When this document is read by image inputting unit 11 (at steps A1 and A2), the document is displayed on the screen of displaying unit 14 as shown in FIG. 3.

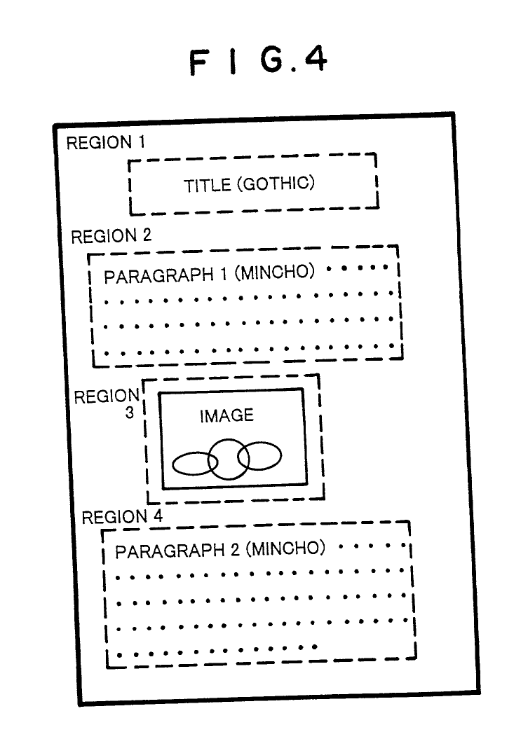

Next, by moving the cursor on the screen with position inputting unit 15, the operator designates a region (at step A3). In this example, as shown in FIG. 4, the operator designates the title, the paragraph 1, the image, and the paragraph 2 as regions 1, 2, 3, and 4, respectively.

In addition, the operator inputs attributive information for each region with character inputting unit 16 (at step A4).

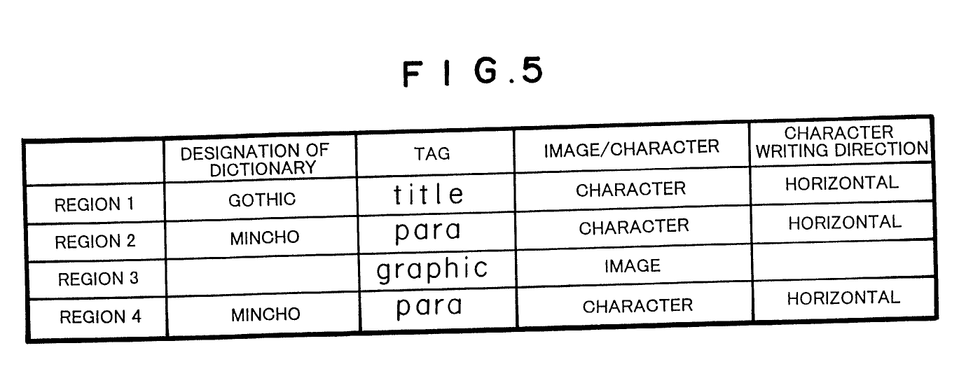

As shown in FIG. 5, the attributive information includes a dictionary type corresponding to font type, a tag used in the markup process, data distinguishing an image region from a character region, and a character writing direction.

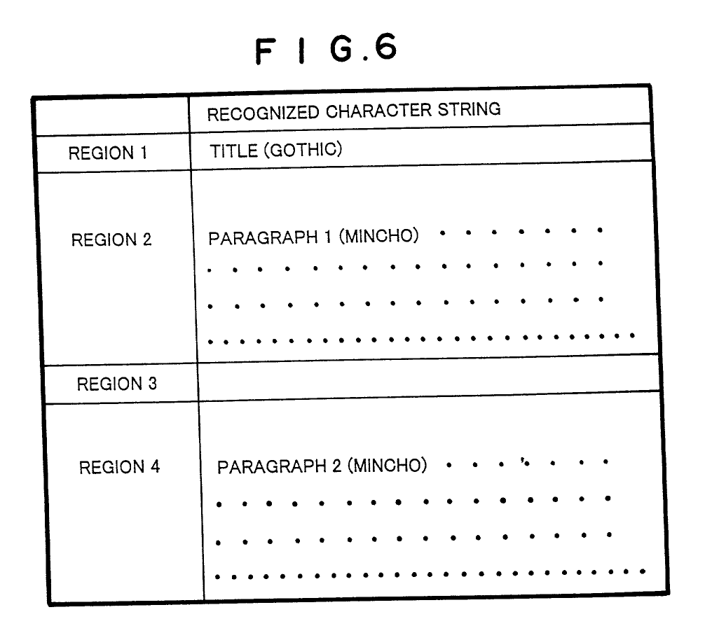

Next, each region is processed. Since the region 1 is a character region as represented by the attributive information (see FIG. 5), it is determined whether or not a dictionary has been designated (at step A11). Since “Gothic” has been designated to the region 1, a character recognizing dictionary that has been optimized for a font “Gothic” is selected (at step A12). With the selected dictionary, characters are automatically recognized with high accuracy. Thus, a character string is recognized as represented with line 2 of FIG. 6. In addition, since “title” has been designated as markup information (tag) to the region 1, “<title>” and “</title> are marked up at the beginning and the end of the recognized character string (at steps A15 and A16). The result is stored in text storing portion 17b.

The region 2 is processed nearly in the same manner as the region 1. As different points from the region 1, “Mincho” has been designated as a dictionary. Thus, a character recognizing dictionary that has been optimized for the font “Mincho” is selected. In addition, since “para” has been designated as a tag, “<para>” and “</para>” are marked up at the beginning and the end of the recognized character string. The region 4 is processed in the same manner as the region 2.

Thus, in the apparatus according to the embodiment of the present invention, even if a document contains a plurality of fonts such as “Gothic” and “Mincho”, with dictionaries designated, characters can be automatically recognized with high accuracy.

The region 3 is an image region as represented by the attributive information. Thus, image data of the region is extracted from image storing portion 12 (at steps A9 and A10). In this case, even if the drawing/chart region contains characters, they are not recognized. The region 3 is marked up with a label “graphic” (at steps A15 and A16).

In the markup process for a drawing/chart region, the file name of image data (for example, a character string “GRAPHIC1.DAT”) is added so that the operator can reference image data of the region. Thus, a character string that has been marked up as “<graphic file=GRAPHIC1.DAT> </graphic>” is stored in text storing portion 17b. In this example, it is assumed that image data is stored in the image data storing portion 17c. Alternatively, image data may be encoded to text data, marked up with labels such as “<graphicdata>” and “</graphicdata>”, and then stored in text storing portion 17b.

When all the regions have been processed, character string data and image data are output from text storing portion 17b and image data storing portion 17c, respectively.

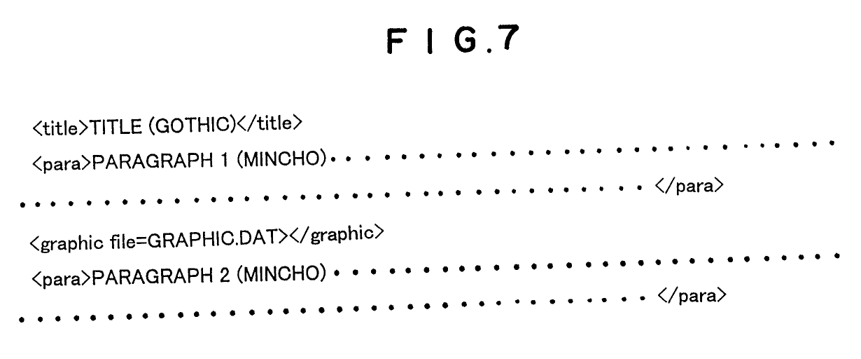

The character string data is output corresponding to the coordinates of regions and attributes of regions input by the operator. In this example, character string data is output successively starting from the region 1. However, concerning an image region, only a character string generated by the markup process is output. The resultant output character string is as shown in FIG. 7.

Following character string, the image data to which a file name is attached so as to be accessed based on the information added in the markup process is output. Thus, the process is completed.

As a first effect of the present invention, even if a document contains a plurality of font types, characters can be automatically recognized with high accuracy.

This is because character recognition is performed using the dictionary with adequate font type assigned for each region selected from a group of dictionaries of which each corresponds to each font type.

As a second effect, a markup process is automatically and effectively performed.

This is because attributive information of individual regions, which are assigned for a document and for which character recognition is performed, contain tag information necessary for the markup process.

As a third effect of the present invention, even if a document contains an image region, the markup process is automatically performed.

This is because attributive information of an image region contains information necessary for the markup process.

Although the present invention has been shown and described with respect to a best mode embodiment thereof, it should be understood by those skilled in the art that the foregoing and various other changes, omissions, and additions in the form and detail thereof may be made therein without departing from the spirit and scope of the present invention.

What is claimed is:

1. An electronic document generating apparatus for reading a document and recognizing characters from said document, which comprises:
region designating means for designating regions of said document;
inputting means for inputting attributive information for said regions;
attribute storing means for storing said regions and said attributive information in such a manner that said regions and said attributive information correlate;
a dictionary group having dictionaries corresponding to a plurality of font types; and
character recognizing means for selecting proper dictionaries from said dictionary group with reference to said attributive information and recognizing characters for said regions.

2. The electronic document generating apparatus as set forth in claim 1, which further comprises:
image extracting means for extracting image data from said region that has been designated as a drawing/chart by said attributive information in case that said document contains said drawing/chart.

3. The electronic document generating apparatus as set forth in claim 1, which further comprises:
markup processing means for executing a markup process for the result of said character recognition for each of the regions.

4. The electronic document generating apparatus as set forth in claim 2, which further comprises:
markup processing means for executing a markup process for the result of said image extraction for each of the regions.

5. An electronic document generating method for reading a document and recognizing characters from said document, which comprises the steps of:
designating regions of said document;
inputting attributive information for said regions;
storing said regions and said attributive information in such a manner that said regions and said attributive information correlate;
selecting proper dictionaries from a dictionary group having dictionaries corresponding to a plurality of font types with reference to said attributive information; and
recognizing characters for said regions.

6. The electronic document generating method as set forth in claim 5, which further comprises the step of:
extracting image data from said region that has been designated as a drawing/chart corresponding by said attributive information in case that said document contains said drawing/chart.

7. The electronic document generating method as set forth in claim 5, which further comprises the step of:
executing a markup process with reference to said attributive information after said characters have been recognized for each of said regions.

8. The electronic document generating method as set forth in claim 6, which further comprises the step of:
executing a markup process with reference to said attributive information after said image data has been extracted for each of said regions.

9. A program, recorded on a record medium, for reading a document and recognizing characters from said document, which comprises the steps of:
designating regions of said document;
inputting attributive information for said regions;
storing said regions and said attributive information in such a manner that said regions and said attributive information correlate;
selecting proper dictionaries from a dictionary group having dictionaries corresponding to a plurality of font types with reference to said attributive information; and
recognizing characters for said regions.

10. The program as set forth in claim 9, which further comprises the step of:
extracting image data from said region that has been designated as a drawing/chart corresponding by said attributive information in case that said document contains said drawing/chart.

11. The program as set forth in claim 9, which further comprises the step of:
executing a markup process with reference to said attributive information after said characters have been recognized for each of said regions.

12. The program as set forth in claim 10, which further comprises the step of:
executing a markup process with reference to said attributive information after said image data has been extracted for each of said regions.
